(19) United States
(12) Patent Application Publication
(10) Pub. No.: US 2015/0341233 A1
(43) Pub. Date: Nov. 26, 2015

(54) METHODS, APPARATUSES, AND ARTICLES FOR LOCATION PARAMETER REPORTING AND PROCESSING

(71) Applicant: QUALCOMM Incorporated, San Diego, CA (US)

(72) Inventors: Subash Marri Sridhar, San Jose, CA (US); Sai Pradeep Venkatraman, Santa Clara, CA (US); Gengsheng Zhang, Cupertino, CA (US)

(21) Appl. No.: 14/286,960

(22) Filed: May 23, 2014

(51) Int. Cl. H04L 12/26; H04W 24/10; H04W 4/00; H04W 4/02

(52) U.S. Cl. CPC H04L 43/045; H04W 4/025; H04W 24/10; H04L 43/0864; H04W 4/005

(57) ABSTRACT

Methods, apparatuses, and articles for location parameter reporting and processing are presented. In one example, a mobile device transmits a probe message to a transceiver device indicating that the mobile device is capable of reporting signal parameter measurements, such as received signal strength (RSSI), round-trip time (RTT), or any combination thereof, for example. Responsive to receipt of a probe message, a wireless transceiver may indicate to the mobile device that the transceiver is capable of utilizing the reported signal parameter measurements to construct or update, for example, localized heatmaps. The mobile device may report signal parameter measurements in response to one or more predetermined events.

### BACKGROUND

1. Field

The subject matter disclosed herein relates to mobile electronic devices, and, more particularly, to methods, apparatuses, and articles of manufacture that may permit reporting of transceiver signal parameters, such as, for example, signal strength and/or round trip time, of signals transmitted by a transceiver and received at the mobile device.

2. Information

The global positioning system (GPS), and other like satellite positioning systems (SPSs), have enabled navigation services for mobile handsets in many types of outdoor environments. However, since satellite signals may not be reliably received and/or acquired in some indoor environments, such as office complexes, shopping malls, indoor stadiums, and so forth, different techniques may be employed to enable indoor navigation services. For example, a mobile device in an indoor environment may begin a position estimation process by measuring parameters of received signals from transceivers, such as wireless access points, positioned at physically separated, known locations. Measured signal parameters may be compared with values from one or more radio heatmaps comprising expected signal parameters at various locations of the indoor environment. The mobile device may estimate its location in the indoor environment by determining a location on the heatmap at which measured signal parameters match predicted signal parameters.

However, developing accurate positioning assistance data, such as indoor heatmaps, may represent a time-consuming process that may require dedicated transceivers and/or specialized measurement equipment. Further, even relatively minor relocations of one or more transceivers, and/or changes in layout of an indoor environment, which may include repartitioning of office cubicles, moving furniture, and so forth, may necessitate an update of indoor heatmaps. A need for frequent update of indoor radio heatmaps may impose a significant burden on information technology personnel, for example, who may be charged with ensuring that accurate, up-to-date positioning assistance is available. Such positioning assistance has become indispensable to employees, visitors, customers, and others, who may occasionally find themselves navigating through unfamiliar indoor environments.

### SUMMARY

Briefly, particular implementations may be directed to a method comprising, at a mobile device, transmitting a probe request message to a transceiver device, the probe request message indicating that the mobile device is capable of reporting signal parameter measurements to the transceiver device. The method may further comprise receiving at least one response message from the transceiver device indicating that the transceiver device is capable of utilizing the reported signal parameter measurements.

Another particular implementation may be directed to a mobile device, comprising a transceiver and one or more processors coupled to the transceiver to initiate transmission of one or more probe request messages indicating that the mobile device is capable of reporting parameter measurements of received wireless signals, and to obtain one or more response messages received at the transceiver indicating that a wireless access point is capable of utilizing the reported parameter measurements of the received wireless signals.

Another particular implementation may be directed to a method comprising, at a transceiver device, receiving a probe request message from a first mobile device, the probe request message indicating that the first mobile device is capable of reporting one or more signal parameter measurements. The method may further comprise the transceiver device transmitting a probe response message to the first mobile device indicating that the transceiver device is capable of utilizing the one or more reported signal parameter measurements. The method may further comprise receiving the one or more signal parameter measurements from the first mobile device and processing the one or more signal parameter measurements to construct or update one or more heatmaps.

Another particular implementation may be directed to a transceiver device comprising a communication interface and one or more processors, coupled to the communication interface, which may be configured to obtain one or more messages from a mobile device indicating that the mobile device is capable of reporting one or more signal parameter measurements. The one or more processors may be additionally configured to initiate transmission of one or more indications, through the communication interface, that the transceiver device is capable of utilizing the one or more reported signal parameter measurements from the mobile device to construct or update one or more heatmaps.

It should be understood that the aforementioned implementations are merely example implementations, and that claimed subject matter is not necessarily limited to any particular aspect of these example implementations.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic diagram of a network topology according to an embodiment.

FIG. 2 is a diagram of an indoor office environment according to an embodiment.

FIGS. 3A-3D are signal flow diagrams showing message traffic between a mobile device and a transceiver according to various embodiments.

FIG. 4A is a schematic diagram showing storage of heatmaps that may be constructed utilizing reported signal parameters according to an embodiment.

FIG. 4B is a schematic diagram showing a transceiver that may be utilized to process reported signal parameter measurements according to an embodiment.

FIG. 4C is a flowchart showing transceiver operations in location parameter reporting and processing according to an embodiment.

FIG. 5 is a flowchart for a method of location parameter reporting and processing according to an embodiment.

FIG. 6 is a schematic diagram of a mobile device according to an embodiment.

FIG. 7 is a schematic block diagram of an example computing platform according to an embodiment.

### DETAILED DESCRIPTION

In the following detailed description, numerous specific details are set forth to provide a thorough understanding of claimed subject matter. However, those skilled in the art will understand that claimed subject matter may be practiced without these specific details. In other instances, methods, apparatuses, and/or systems that would be known by one of ordinary skill have not been described in detail so as not to obscure claimed subject matter.

As used herein, “mobile electronic device,” “mobile device,” “wireless device,” or the plural form of such terms, may be used interchangeably and may refer to any kind of special purpose computing platform or apparatus that may from time to time occupy a position that changes. In some instances, a mobile communication device may, for example, be capable of communicating with other devices, mobile or otherwise, through wireless transmission or receipt of information according to one or more communication protocols. As a way of illustration, special purpose mobile communication devices, which may herein be referred to simply as “mobile devices,” may include, for example, cellular telephones, smart telephones, personal digital assistants, wearable computers, wrist phones, laptop computers, personal entertainment systems, tablet personal computers, personal audio or video devices, personal navigation devices, or the like. It should be appreciated, however, that these are merely examples of mobile devices that may be used, at least in part, to implement one or more operations and/or techniques for estimating a position of a mobile device, for example, and that claimed subject matter is not limited in this respect. It should also be noted that the terms “position” and “location” may be used interchangeably herein.

As used herein, “wireless access point,” may refer to any electronic device that permits a wireless device to couple and/or connect to a wired network, such as the Internet, an Ethernet, or any other type of wired network, using wireless communications protocols. A wireless access point may comprise a network adapter, antenna, wireless transmitter, wireless receiver, processor, and memory storage. A wireless access point may wirelessly communicate with, for example, a mobile device using and IEEE Std. 802.11 protocol, for example, but may communicate using any other wireless communications standard.

As used herein, a “radio heatmap” or simply a “heatmap” may refer to a particular type of positioning assistance data. A heatmap may comprise an array of grid points, wherein each grid point represents a discrete location of a two-dimensional indoor area, for example. For each grid point of a heatmap, one or more transceiver Media Access Control Identifiers (MAC IDs) may be provided along with expected signal parameters for each MAC ID. Expected signal parameters for each MAC ID may comprise received signal strength (RSSI), signal round trip time (RTT), standard deviation of RSSI and/or RTT, etc. Expected signal parameters of a radio heatmap may be determined by way of, for example, prior measurement and may be stored in a database, at least a portion of which may be downloaded to a mobile device upon or soon after entering an indoor area. By utilizing a heatmap, a mobile device may estimate its location by comparing measured signal parameters with expected signal parameters of a heatmap until a grid point is found at which measured and expected signal parameters are in agreement.

However, as previously discussed, developing accurate indoor heatmaps, such as RSSI and/or RTT heatmaps, may represent a time-consuming process that may involve dedicated transceivers and/or specialized signal parameter measurement equipment. Further, minor relocations of transceivers and/or changes in layout of office furniture, for example, may necessitate an update of heatmaps, for example. Accordingly, in certain embodiments, a mobile device may be provided with a capability to report measured signal parameters, such as RSSI and/or RTT measurements, to one or more transceiver devices, such as wireless access points. In particular embodiments, if a mobile device is capable of estimating its current location, the mobile device may pair, associate, or relate its estimated location with transceiver signal parameter measurements for reporting to a transceiver.

In one possible example, if a mobile device is positioned at an entrance to an indoor area, the mobile device may detect one or more indoor transceivers broadcasting, for example, MAC ID addresses. Accordingly, if the mobile device is capable of estimating, for example, latitude and longitude of its present location at the entrance to the doorway, the mobile device may indicate a capability to report transceiver signal parameter measurements to the one or more broadcasting transceivers. After receiving one or more response messages from a transceiver, which may indicate a transceiver's capability to utilize reported signal parameter measurements to construct, complement, and/or update heatmaps, for example, the mobile device may transmit measured signal parameters. The mobile device may pair, associate, or relate signal parameter measurements with estimates of longitude and latitude obtained contemporaneously with parameter measurements for reporting to a transceiver.

A mobile device may utilize a “probe request message,” comprising one or more parameters transmitted through a wireless communications channel, to indicate a capability for reporting measured signal parameters. A transceiver, such as a wireless access point, may be coupled to the wireless communications channel and may consequently receive the probe request message. Responsive to receipt of the probe request message, the wireless transceiver may respond with a “probe response message,” which may comprise, among other parameters, a basic service set identifier (BSSID) to identify the transceiver (e.g., wireless access point) and services that may be provided by the transceiver. The probe response message may be utilized by the mobile device to determine transceivers that may provide communication and/or navigation services, such as positioning assistance, download of electronic digital maps, Internet access, and so forth.

In particular embodiments, a mobile device and a wireless transceiver may communicate using an IEEE Std. 802.11 protocol. Accordingly, a mobile device may initiate discovery of one or more transceivers by transmitting a probe request message during a “request-to-send” message frame. After transmitting the probe request message, a mobile device may monitor or scan a communications channel in an attempt to detect one or more signals from the wireless transceiver. Monitoring or scanning of a frequency channel may enable the mobile device to receive a probe response message frame during a “clear-to-send” message frame, for example, from the wireless transceiver.

In some embodiments, a probe request message may comprise a “vendor-specific information element” (VSIE), as described in IEEE Std. 802.11. A VSIE may be used to indicate a capability of a mobile device to report characteristics of received signals, such as RSSI and/or RTT measurements. In one particular example, a first portion of a VSIE may comprise a unique identifier and a capability indicator, which may inform a transceiver that the mobile device is capable of reporting RSSI measurements. Responsive to receipt of a probe request message comprising a VSIE, a transceiver may respond with a probe response message, which may indicate a capability of the transceiver for utilizing signal parameters measured by a mobile device to construct, update, or complement one or more indoor heatmaps, for example. In certain embodiments, a probe response message may comprise additional parameters which may, for example, provide a mobile device with communication parameters, such as protocols, symbol rate settings, and so forth, and claimed subject matter is not limited in this respect.

In certain embodiments, if a mobile device is capable of reporting signal parameters and corresponding location estimates that may be utilized by a transceiver, the mobile device may transmit a signal parameter measurement message. A signal parameter measurement message may comprise, for example, one or more RSSI measurements, one or more RTT measurements, and one or more standard deviations of RSSI and/or RTT measurements. In particular embodiments, a mobile device may qualify transceiver parameter measurements using a reliability indicator. Responsive to receipt of one or more signal parameter measurement messages, a transceiver, such as a wireless access point, may transmit an acknowledgment to the mobile device. Additional messages may be exchanged among mobile devices and transceivers, and claimed subject matter is not limited in this respect.

In particular embodiments, responsive to detection of one or more predetermined events, a mobile device may report signal parameter measurements, such as RSSI and/or RTT measurements. For example, responsive to detection of movement based, at least in part, on output signals from one or more on board sensors (e.g., RF sensors, accelerometers, magnetometers, etc.), the mobile device may report updated signal parameters. In another example, a predetermined event, such as a mobile device estimating its position based, at least in part, on a trilateration approach, may give rise to the mobile device reporting signal parameter measurements.

In another example, a predetermined event that may give rise to a mobile device reporting signal parameter measurements may comprise a mobile device detecting one or more predetermined times of day, such as near a beginning and/or near an end of a business day. In another example, a predetermined event that may give rise to a mobile device reporting signal parameter measurements may comprise a request from a transceiver, such as a wireless access point. In another example, a predetermined event that may give rise to a mobile device reporting signal parameter measurements may comprise a processor receiving one or more input signals from a user interface of the mobile device. Additional predetermined events may bring about a mobile device reporting measured signal parameters (e.g., RSSI, RTT, standard deviation of one or more or RSSI and RTT, and so forth) and claimed subject matter is not limited in this respect.

In particular embodiments, a transceiver, such as a wireless access point, may utilize reported signal parameters, such as RSSI, RTT, standard deviation of one or more or RSSI and RTT, and so forth, to assist in forming, complementing, and/or updating an indoor heatmap, for example. Reported signal parameter measurements may be transmitted to one or more servers, such as map servers, and integrated with pre-existing heatmaps to construct one or more updated heatmaps, for example. Responsive to updating of heatmaps, a transceiver, such as a wireless access point, may advertise or notify mobile devices that updated heatmaps may be available for download to a mobile device. Transceivers, such as wireless access points, as well as location servers may utilize reported signal parameter measurements in other modes, and claimed subject matter is not limited in this respect.

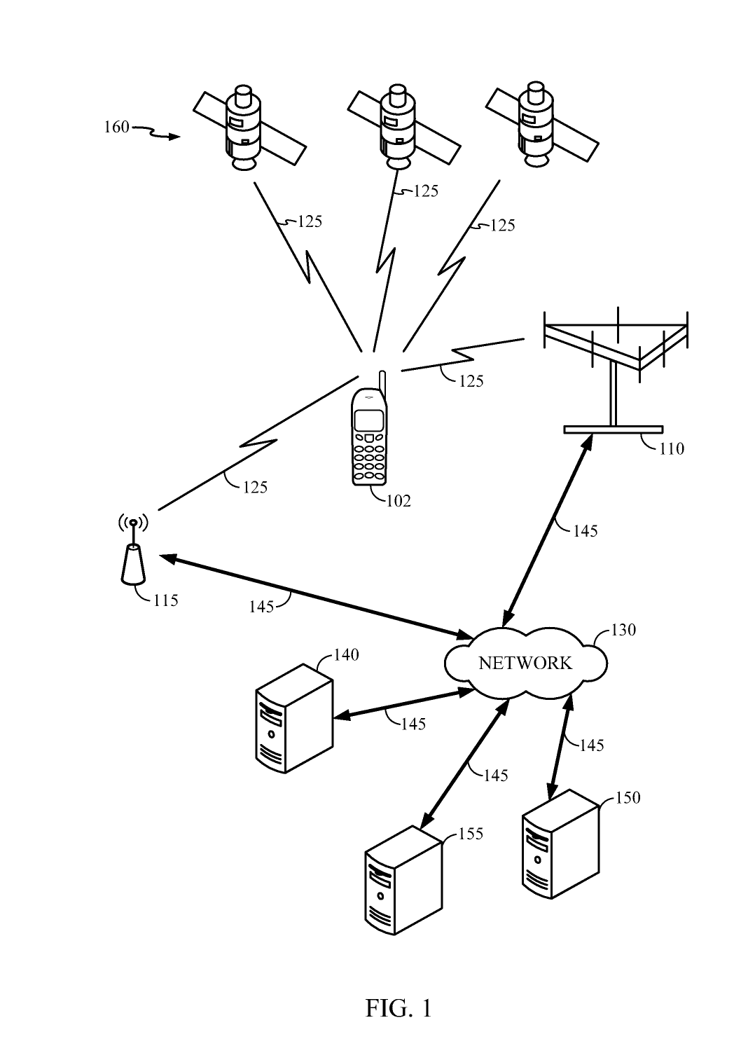

FIG. 1 is a schematic diagram of a network topology 100 according to an embodiment. As described below, one or more processes or operations for mobile device-based transceiver parameter reporting may be implemented in a signal environment that may be utilized by mobile device 102, for example. It should be appreciated that network topology 100 is described herein as a non-limiting example that may be implemented, in whole or in part, in the context of various communications networks or combination of networks, such as public networks (e.g., the Internet, the World Wide Web), private networks (e.g., intranets), wireless local area networks (WLAN, etc.), or the like. It should also be noted that claimed subject matter is not limited to any particular type of outdoor or indoor implementation. For example, at times, one or more operations or techniques described herein may be performed, at least in part, in an environment that may dense urban environments, suburban environments, rural environments, etc., and claimed subject matter is not limited in this respect.

As illustrated, network topology 100 may comprise, for example, one or more space vehicles 160, cellular base station 110, wireless transceiver 115, etc. capable of communicating with mobile device 102 via wireless communication links 125 in accordance with one or more protocols. Space vehicles 160 may represent one or more satellites associated with a satellite positioning system of a GNSS, such as, for example, the United States Global Positioning System (GPS), the Russian GLONASS system, the European Galileo system, as well as any system that may utilize space vehicles from a combination of SPSs, or any SPS developed in the future. Space vehicles 160 may also represent one or more orbiting space vehicles of a regional satellite navigation system such as, for example, Quasi-Zenith Satellite System (QZSS) over Japan, Indian Regional Navigational Satellite System (IRNSS) over India, Beidou/Compass over China, etc., and/or various augmentation systems (e.g., an Satellite Based Augmentation System (SBAS)) that may be associated with or otherwise enabled for use with one or more global and/or regional navigation satellite systems. It should be noted that claimed subject matter is not limited to the use of space vehicles such as those space vehicles of the aforementioned global or regional satellite navigation systems. Cellular base station 110, wireless transceiver 115, etc. may be of the same or similar type, for example, or may represent different types of devices, such as access points, radio beacons, cellular base stations, femtocells, or the like, depending on an implementation. At times, one or more wireless transmitters, such as wireless transceivers 115, for example, may be capable of transmitting as well as receiving wireless signals.

In some instances, one or more cellular base stations 110, wireless transceivers 115, etc. may, for example, be operatively coupled to a network 130 that may comprise one or more wired or wireless communications or computing networks capable of transmitting messages including items, such as an electronic digital map, that may be relevant to a mobile device user's estimated location via one or more wireless communication links 125, 145, and so forth.

Even though a certain number of computing platforms or devices are illustrated herein, any number of suitable computing platforms or devices may be implemented to facilitate or otherwise support one or more techniques or processes associated with network topology 100. For example, at times, network 130 may be coupled to one or more wired or wireless communications networks (e.g., Wi-Fi, etc.) so as to enhance a predominantly indoor coverage area for communications with mobile device 102, one or more cellular base stations 110, wireless transceivers 115, servers 140, 150, 155, or the like. In some instances, network 130 may facilitate or support femtocell-based operative regions of coverage, for example. Again, these are merely example implementations, and claimed subject matter is not limited in this regard.

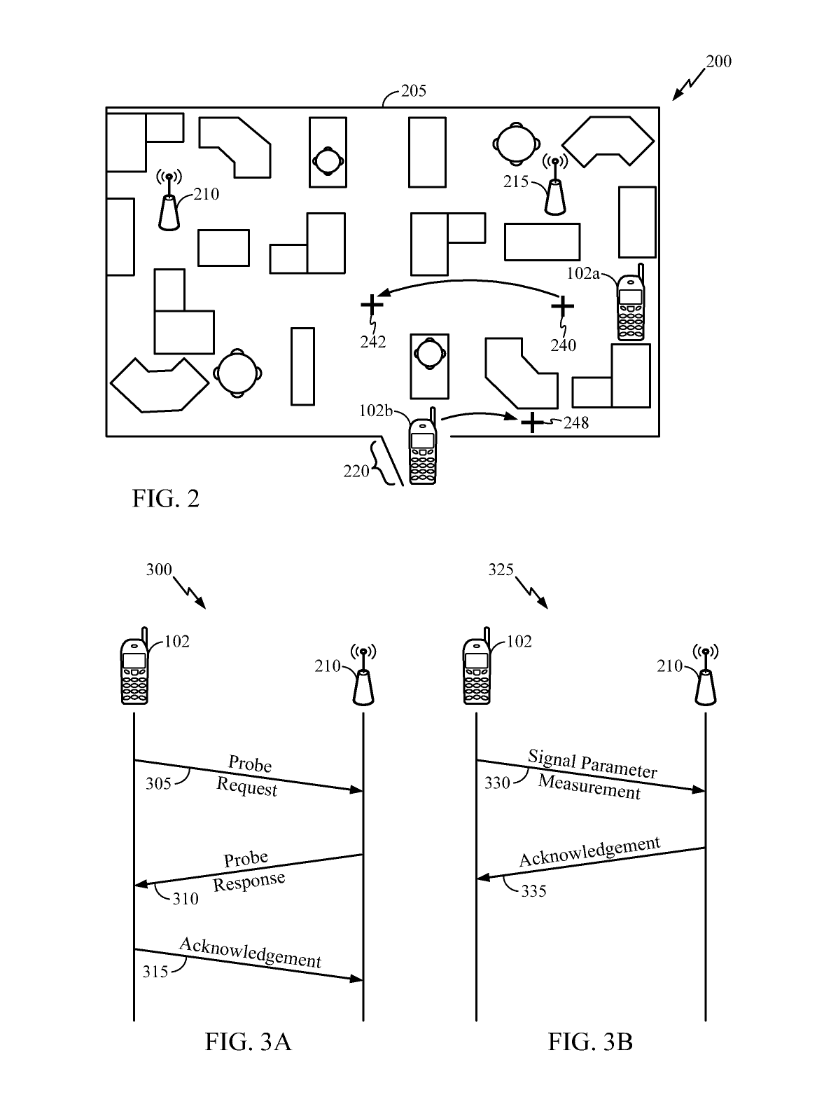

FIG. 2 is a diagram 200 of an indoor office environment according to an embodiment. In FIG. 2, wireless access points 210 and 215 may be situated within indoor area 205 and be in communication with mobile device 102a, for example. Although only two wireless access points are shown in the example of FIG. 2, other example embodiments may utilize a greater number of wireless transceivers, such as four transceivers, five transceivers, and so forth, and claimed subject matter is not limited in this respect. Further, although indoor area 205 may represent an office environment, claimed subject matter is not limited to use within particular types of indoor or partially indoor areas. For example, embodiments of claimed subject matter may be utilized in shopping malls, nightclubs, amphitheaters, stadiums, concert halls, parking garages, and so forth.

In FIG. 2, mobile device 102a may acquire wireless signals from access points within range of mobile device 102a, such as access points 210 and 215, as well as additional wireless access points and transceivers not shown in FIG. 2. In certain embodiments, a mobile device may utilize MAC ID addresses and/or other identifiers to distinguish among wireless signals acquired from access points. If wireless signals are acquired, mobile devices 102a and 102b may report transceiver signal parameter measurements, such as RSSI and/or RTT, to one or more of wireless access points 210 and 215. In particular embodiments, mobile devices 102a and 102b may indicate a capability of measuring and reporting transceiver signal parameters by transmitting a probe request message to one or more of wireless access points 210 and 215. It should be noted that a probe request message may represent just one approach, among many different approaches, that may be utilized to indicate to a transceiver that a mobile device is capable of reporting signal parameter measurements, and claimed subject matter is not limited in this respect. In an embodiment, responsive to receipt of one or more probe request messages, for example, wireless access point 210 and/or 215 may transmit a response message, such as a probe response message. A probe response message may indicate a capability of the transceiver to utilize reported signal parameter measurements, such as RSSI, RTT, and/or a standard deviation of one or more of RSSI and RTT, for example to assist in forming, updating, and/or complementing one or more heatmaps, for example.

In embodiments, responsive to one or more of wireless access points 210 and 215 indicating a capability of utilizing transceiver signal parameter measurements, mobile device 102a may report RSSI and/or RTT measurements, for example, to wireless access points 210 and/or 215. Responsive to receipt of transceiver signal parameter measurements, one or more of wireless access points 210 and/or 215 may construct a heatmap (e.g., for use as positioning assistance data) that may comprise expected signal parameters of signals transmitted from wireless access points in range of mobile device 102a. Positioning assistance data, such as one or more heatmaps, for example, may be distributed among wireless access points and may be made accessible for download to mobile devices within area 205. In some instances, upon or soon after entry into an area, a mobile device may initiate a handshaking or other type of signaling operation, which may give rise to one or more access points downloading positioning assistance data for area 205.

Accordingly, wireless access point 210 may collect and store signal parameter measurements relating, associating, or paired with signals transmitted from wireless access point 210 and acquired by mobile device 102a. Likewise, wireless access point 215 may collect and store signal parameter measurements relating, associating, or paired with signals transmitted from wireless access point 215 and acquired by mobile device 102a. In certain embodiments, signal parameter measurements may be stored at an individual transceiver, such as wireless access points 210 and/or 215, for example, and in place of storing heatmaps at an intermediary location server or map server. In embodiments, such local storage of heatmaps may reduce a need for a central map server and/or positioning assistance data server to provide assistance data to mobile device 102a.

In possible examples, mobile device 102a may report an RSSI measurement of a beacon signal from wireless access point 215 as approximately −60.0 dBm and may report an RSSI measurement of the beacon signal from wireless access point 210 as approximately −75.0 dBm. Mobile device 102a may report RSSI measurements, for example, of any measurable signal level, such as signal levels greater than approximately 0.0 dBm and signal levels of less than approximately 0.0 dBm, such as approximately −50.0 dBm, approximately −90.0 dBm, and claimed subject matter is not limited in this respect. Further, mobile device 102a may report RTT measurements, for example, within any time period, such as less than approximately 1.0 μs, approximately 2.0 μs, approximately 3.0 us or more, and claimed subject matter is not limited in this respect.

As previously discussed, in embodiments, mobile device 102a may be equipped with a sensor suite, comprising one or more accelerometers, RF sensors, magnetometers, barometric pressure sensors, and so forth, which may enable the mobile device to detect its movement within indoor area 205. Thus, as mobile device 102a moves from location 240 to location 242, for example, the sensor suite may enable the mobile device to update estimates of its location. Contemporaneous with computing updated position estimates at location 242, for example, mobile device may measure parameters of signals transmitted from wireless access points 210 and/or 215. Thus, at these locations and at other locations within indoor area 205, mobile device 102a may report transceiver signal parameter measurements, such as RSSI and/or RTT measurements, along with corresponding position estimates.

In FIG. 2, mobile device 102b is shown as positioned at a location near doorway 220 representing a physical entrance to area 205. In embodiments, contemporaneous with entry into area 205, mobile device 102b may detect signals transmitted from wireless access points 210 and/or 215, for example. Responsive to receipt of signals from one or more of wireless access points 210 and 215, mobile device 102b may estimate its current position. For example, if doorway 220 opens to an outside area, mobile device 102b may have previously computed a position estimate based, at least in part, on positioning signals from one or more of space vehicles 160 (e.g., of FIG. 1). In another example, mobile device 102b may obtain a partially complete heatmap, which may enable the mobile device to estimate its location based, at least in part, on measurement of RSSI and/or RTT from wireless access points 210 and/or 215 in association with heatmap elements. In other embodiments, mobile device 102b may utilize other approaches to estimate its location at or near location 246, and claimed subject matter is not limited in this respect.

In certain embodiments, upon entry into area 205, mobile device 102b may transmit a probe request message to transceiver devices, such as wireless access points 210 and/or 215. A probe request message may comprise parameters indicating that mobile device 102b may be capable of reporting measured parameters of signals originating from, for example, wireless access points 210 and/or 215. Upon receipt of one or more probe request messages, wireless access points 210 and/or 215 may respond by transmitting one or more probe response messages, for example, which may include one or more parameters indicating that the wireless access point is capable of utilizing reported signal parameter measurements, such as RSSI and/or RTT, for example, in assisting in forming, updating, and/or complementing one or more heatmaps. As mobile device 102b relocates from doorway 220, for example, to location 248, a sensor suite, which may comprise accelerometers, magnetometers, and so forth, may be utilized to compute an updated position estimate of mobile device 102b. At or near location 248, for example, mobile device 102b may update transceiver signal parameter measurements of signals transmitted from wireless access point 210 and/or 215. As discussed previously herein, reported signal parameter measurements may enable one or more of access points 210 and/or 215 to construct or update a heatmap that may relate to a number wireless access points operating in a localized area, such as area 205.

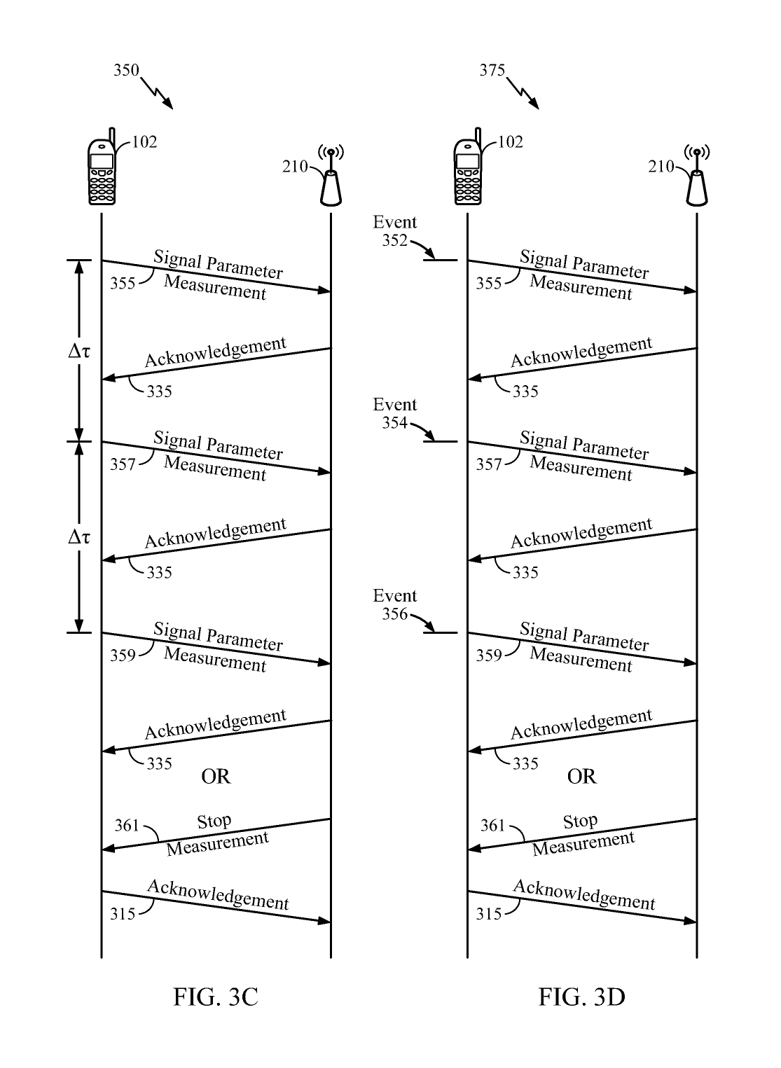

FIGS. 3A-3D are signal flow diagrams showing message traffic between a mobile device and a transceiver according to various embodiments. Beginning with diagram 300 of FIG. 3A, mobile device 102 may communicate with a transceiver, such as wireless access point 210 which may be positioned within an indoor area, such as area 205 of FIG. 2. In certain embodiments, mobile device 102 may offer to report signal parameter measurements based, at least in part, on the mobile device comprising adequate computer processing resources, a presence of software modules enabling such parameter measurement and reporting, a presence of adequate security and/or authentication protocols, and so forth. Additionally, the mobile device may offer to report signal parameter measurements based, at least in part, on the presence of adequate battery resources, positive link margin, an abundance of bandwidth of a communications channel between the mobile device and the transceiver, and other physical layer considerations.

Accordingly, mobile device 102 may transmit probe request message 305, which may function to notify access point 210 of a capability for reporting signal parameter measurements. In certain embodiments, mobile device 102 may transmit one or more indicators of the mobile device's capability of reporting signal parameter measurements, such as RSS and/or RTT, to a transceiver, such as wireless access point 210. In particular embodiments, mobile device 102 may obtain or compute a current estimated location prior to indicating a capability for reporting signal parameter measurements.

Responsive to receipt of one or more parameters indicating that mobile device 102 may be capable of reporting transceiver signal parameter measurements, wireless access point 210 may transmit probe response message 310. Responsive to receipt of probe response message 310, mobile device 102 may transmit, for example, acknowledgment 315, which may inform access point 210 that mobile device 102 may commence reporting signal parameter measurements. It should be noted that although a particular message structure, comprising a probe request, probe response, and acknowledgment messages may be described, claimed subject matter is intended to embrace all types of message structures without limitation. In a non-limiting example, as discussed previously herein, a probe request message may comprise a VSIE, as described in IEEE Std. 802.11. Likewise, a probe response message may comprise a VSIE which may accord with, for example, IEEE Std. 802.11.

FIG. 3B is a signal flow diagram 325 of mobile device 102 reporting a single signal parameter measurement to an access point according to an embodiment. In the embodiment of FIG. 3B, which may occur in response to receipt of probe response message 310 (FIG. 3A), mobile device 102 may report a single signal parameter measurement 330 to wireless access point 210 using, for example, a signal parameter measurement frame. Signal parameter measurement 330 may comprise one or more indicators to inform wireless access point 210 that an accompanying signal parameter measurement represents a single (e.g., one time) measurement comprising one or more RSSI measurements, RTT measurements, and/or one or more standard deviations of an RSSI measurement and/or RTT measurements, for example. In another embodiment, signal parameter measurement 330 may occur responsive to a predetermined event such as, for example, a request for signal parameter measurements from access point 210, for example. In certain embodiments, signal parameter measurements may additionally comprise MAC ID addresses or other indications of transceivers to which signal parameter measurements may pertain. In particular embodiments, wireless access point 210 may respond to signal parameter measurement 330 from mobile device 102 utilizing, for example, acknowledgment 335.

FIG. 3C is a signal flow diagram 350 of mobile device 102 reporting periodic signal parameter measurements to an access point according to an embodiment. In the embodiment of FIG. 3C, mobile device 102 may utilize an internal timer, which may function to bring about periodic reporting of signal parameter measurements to wireless access point 210. Accordingly, signal parameter measurement 355 may be reported to access point 210 which may, responsive to receipt of measurement 355, transmit acknowledgment 335. After expiration of a timing period (Δτ), mobile device 102 may report signal parameter measurement 357, which may be followed by access point 210 transmitting, for example, acknowledgment 335. After expiration of a second expiration of a timing period (Δτ), mobile device 102 may report signal parameter measurement 359, which may be followed by access point 210 transmitting, for example, acknowledgment 335.

In certain embodiments, periodic signal parameter measurements, such as measurements 357 and 359, and acknowledgments, such as acknowledgment 335, may continue indefinitely. In the embodiment of FIG. 3C, provided that mobile device 102 is capable of reporting signal parameter measurements and provided that wireless access point 210 is capable of utilizing reported signal parameter measurements, access point 210 may continue to collect signal parameter measurements. In embodiments, if access point 210 is no longer capable of utilizing reported signal measurement parameters, access point 210 may utilize stop measurement message 361. Stop measurement message 361 may be transmitted, for example, responsive to access point 210 undergoing a decrease in processing bandwidth, for example, a decrease in communications channel capacity, and/or in response to other conditions, and claimed subject matter is not limited in this respect.

FIG. 3D is a signal flow diagram 375 of mobile device 102 reporting signal parameter measurement to an access point according to an embodiment. In FIG. 3D, predetermined events 352, 354, and 356 may give rise to a mobile device 102 reporting signal parameter measurements to wireless access point 210. For example, predetermined event 352, which may represent movement of mobile device 102, may bring about signal parameter measurement 355. In one embodiment, for example, if mobile device 102 has undergone movement of approximately 1.0 meter, approximately 2.0 meters, or any other distance greater than a lower threshold, mobile device 102 may report signal parameter measurement 355. In embodiments, obtaining reported signal parameter measurements in this manner may enable access point 210 to construct or update heatmaps covering a portion or even an entire indoor area in range of access point 210, for example. In a manner similar to that of FIG. 3C, responsive to receipt of measurement 355, for example, access point 210 may transmit acknowledgment 335.

In an embodiment, a predetermined event may be represented as event 354 which may correspond to a mobile device recognizing an increase in processing capacity (e.g., perhaps in response to recent completion of a higher priority task). In response, mobile device 102 may report signal parameter measurement 357 to access point 210. In an embodiment, predetermined event 356, which may correspond to a mobile device receiving an input from a user, such as a user expressing a choice to assist in mobile device signal parameter reporting, may give rise to the mobile device reporting signal parameter measurement 359.

In a manner similar to that of FIG. 3C, provided that mobile device 102 is capable of reporting signal parameter measurements and provided that wireless access point 210 is capable of utilizing reported signal parameter measurements, predetermined events may give rise to the mobile device reporting signal parameter measurements. In embodiments, if access point 210 is no longer capable of utilizing reported signal measurement parameters, access point 210 may utilize stop measurement message 361.

In certain embodiments, reported signal parameter measurements and estimated locations of a mobile device may be accompanied by a qualifier, which may function to indicate reliability of an estimate of its location. A qualifier may be represented by a one-byte or two-byte digital word, for example, that may be appended or prepended to a signal parameter measurement. In certain embodiments, if a mobile device computes an estimated location in response to acquiring positioning signals from an SPS, the mobile device may assign a qualifier to indicate a relatively high level of confidence in the accuracy of a reported estimated location. However, if a mobile device computes an estimated location without acquiring positioning signals from an SPS, which may involve the mobile device estimating its location utilizing dead reckoning, the mobile device may assign a lower value for an accompanying qualifier.

In particular embodiments, a qualifier may also be utilized to indicate reliability of signal parameter measurements reported by a mobile device. For example, a mobile device may assign a qualifier to indicate relatively low reliability in signal parameter measurements if, for example, measured signal characteristics fluctuate more than a threshold amount over consecutive measurement intervals. In one possible example, if a mobile device measures a deviation RSSI of greater than approximately 50.0 dBm over an approximately 30.0-second period, the mobile device may indicate low reliability in reported RSSI. In another example, if measured RSSI values exhibit above average consistency, a mobile device may assign a qualifier indicating relatively high reliability in reported RSSI.

In certain embodiments, a mobile device may be preloaded with an estimated location (e.g., longitude, latitude, and height) of a transceiver, such as an access point. Further, a transceiver may be further preloaded with parameters to indicate geometrical constraints comprising, for example, one or more directions in which interfering structures may be present between the transceiver and the mobile device. Thus, if a mobile device estimates its location as behind an interfering structure, relative to the estimated location of a transceiver, the mobile device may accompany signal parameter measurements with a qualifier to indicate that RSSI measurements, for example, may represent a lower reliability measurement. In contrast, however, if a mobile device estimates its location as being within a line of sight of a transceiver, the prime the mobile device may accompany signal parameter measurements with a qualifier to indicate higher reliability of measured signal parameters.

In some embodiments, a qualifier may comprise a value of, for example, less than approximately 0.25, which may indicate relatively low reliability in an estimate of location or signal parameter measurement. A qualifier may also comprise values greater than approximately 0.9, which may indicate relatively high reliability in an estimate of location or a signal parameter measurement. However, claimed subject matter is intended to embrace any and all values of qualifiers or other types of indicators of reliability of estimated location and/or signal parameter measurements, without limitation.

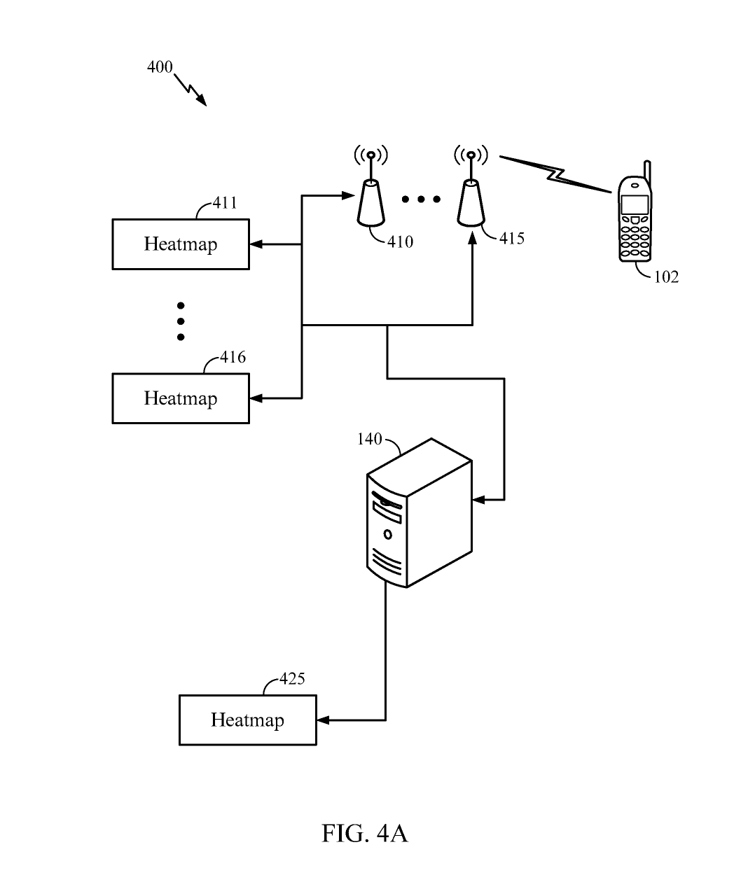

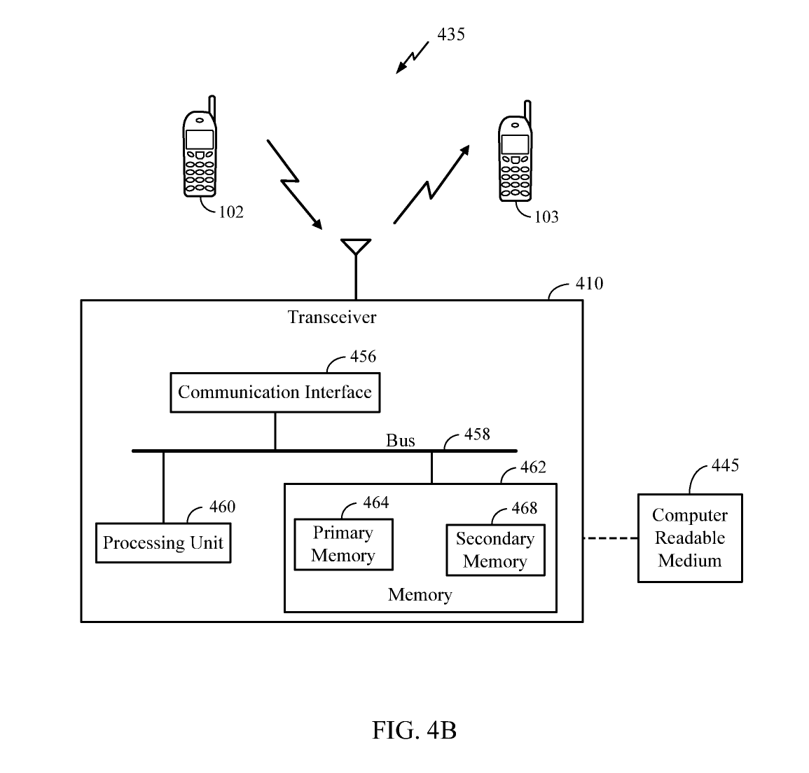

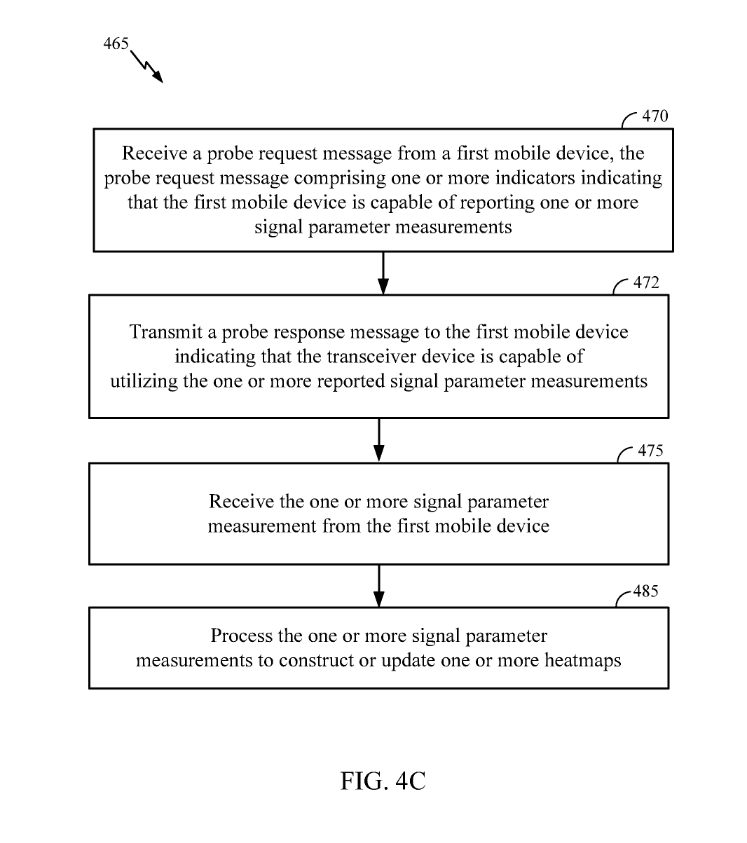

FIG. 4A is a schematic diagram 400 showing storage of heatmaps constructed utilizing reported signal parameters according to an embodiment. In FIG. 4, wireless access points 410 and 415 may represent transceivers capable of utilizing reported signal parameter measurements from, for example, mobile device 102, so that heatmaps 411 and/or 416 may be constructed. Alternatively, heatmaps 411 and/or 416 may correspond to pre-existing heatmaps, which may be updated utilizing reported signal parameters, for example. In particular embodiments, mobile device 102 may report signal parameters such as RSSI and/or RTT, estimates of mobile device location, and one or more qualifiers indicating reliability of an estimated location and/or reliability of one or more signal parameter measurements.

In particular embodiments, reported signal parameters for transceivers, such as wireless access points, may be accompanied by, for example, a MAC ID address, which may enable wireless transceivers, such as wireless access points, to construct or update heatmaps for individual wireless access points. Accordingly, as shown in FIG. 4, wireless access point 410 may collect reported signal parameter measurements to enable construction of heatmap 411, for example, which may represent positioning assistance data accessible by mobile device 102. In an embodiment, heatmap 411 may comprise measured signal parameters relevant to a localized area that may include access point 410. Wireless access point 415 may collect reported signal parameter measurements to enable construction of heatmap 416, which may comprise signal parameter measurements collected by wireless access point 415. Thus, in the example FIG. 4, wireless access points 410 and 415 may collect reported signal parameters from mobile devices, such as mobile device 102, which may be in range of access points 410 and 415.

In the example of FIG. 4, heatmap 416, which may be computed from reported signal parameter measurements of wireless access point 415, may be made accessible for downloading to mobile devices in communication with wireless access point 415. In certain embodiments, one or more of access points 410 and/or 415 may broadcast to mobile devices in a localized area, such as mobile device 102, one or more indicators to indicate that a heatmap may be available for download and subsequent use by mobile devices. In particular embodiments, heatmaps may be constructed utilizing processing techniques which may involve, for example, averaging of multiple RSSI and/or RTT measurements taken at or nearby discrete grid point locations of an indoor area, for example. In certain embodiments, two or more signal parameter measurements taken proximate to a discrete grid point location may be interpolated so as to provide an estimate of an RSSI and/or RTT value that may be expected at the grid point location. Processing techniques may involve computation of standard deviations in RSSI and/or RTT values, use of qualifiers to indicate reliability of signal parameter measurements and/or estimated locations of mobile devices. In particular embodiments, processing of signal parameter measurements may involve a use of weighting functions, in which higher reliability measurements and/or estimated locations may be assigned greater weights, and lower reliability measurements and/or estimated locations may be assigned lesser weights, for example.

One or more of heatmaps 411 and 416 may additionally be used to complement heatmaps accessible to, for example, server 140, which may function as a location server. In one possible example, server 140 may determine that sufficiently high reliability RSSI and/or RTT measurements for one or more discrete grid points of an indoor area are not present in a heatmap. Thus, server 140 may contact one or more of access points 410 and 415 to request copies of at least portions of heatmaps 411 and/or 416. In response to a request from server 140, access points 410 and/or 415 may transmit relevant portions of heatmaps, along with additional positioning assistance data, to server 140. Responsive to receipt of one or more portions of heatmaps, server 140 may complement heatmap 425 with, for example, values for RSSI and/or RTT that may be expected at certain discrete grid points. Thus, server 140 may transmit positioning assistance data, such as completed heatmaps and electronic digital maps, for example, to mobile device 102 and to other mobile devices not shown in FIG. 4.

In some embodiments, one or more of wireless access points 410 and 415 may be preloaded with an estimated location of itself (e.g., longitude, latitude, and height). Such preloading may enable a wireless access point, or other type of transceiver, to assign a qualifier to one or more reported signal parameter measurements from a mobile device, for example. In such an embodiment, a qualifier indicating low reliability in a measurement may be assigned if a wireless access point receives a reported signal parameter measurement that appears to be inconsistent with a mobile device's estimated position. In one possible example, if a wireless access point receives an RSSI measurement of a relatively high level (e.g., −30.0 dBm) that is paired, associated, or related with a mobile device estimated location of approximately 50.0 meters from the wireless access point, a qualifier may be assigned to indicate low reliability in the measurement. However, if a relatively high level (e.g., −30.0 dBm) RSSI measurement is paired, associated, or related with a mobile device estimated location of approximately 1.0 meters from the wireless access point, a qualifier may be assigned to indicate higher reliability in the measurement. In some embodiments, reports of high level RSSI measurements may enable a wireless access point estimate and/or confirm its new location after being relocated to a new area, for example.

In certain embodiments, one or more of wireless access points 410 and 415 may be preloaded with an estimated location of the access point along with geometrical constraints of a surrounding area. For example, access point 410 may be made aware of the presence of a nearby concrete wall or pillar, for example. Accordingly, reported signal parameter measurements that may appear to originate from mobile devices at estimated locations behind the concrete wall or pillar may be assigned a qualifier indicating low reliability in the measurement. In contrast, however, reported signal parameter measurements that may appear to originate from mobile devices within a line of sight of a transceiver, may be accompanied a qualifier to indicate higher reliability of reported signal

FIG. 4B is a schematic diagram 435 showing a transceiver that may be utilized to process reported signal parameter measurements according to an embodiment. In the embodiment of FIG. 4B, mobile device 102 may perform signal parameter measurements of, for example, RSSI and RTT of signals emanating from transceiver 410. In certain embodiments, transceiver 410 may represent a wireless access point, for example, although claimed subject matter is not limited in this respect. For example, transceiver 410 may receive a probe request message comprising in indicator, which may indicate that mobile device 102 is capable of reporting transceiver signal parameter measurements.

Responsive to receipt of a probe request message, transceiver 410 may begin to receive signal parameter measurements from mobile device 102. Transceiver 410 may process by way of processing unit 460, received signal parameter measurements to construct and/or update one or more heatmaps for a localized area, such as an area within wireless communications range of transceiver 410. Processing unit 460 may be representative of one or more circuits configurable to perform at least a portion of a data computing procedure or process, such as assigning a greater weight to a relatively high reliability transceiver signal parameter measurement and assigning a lesser weight to a relatively low reliability transceiver signal parameter measurement. Processing unit 460 may additionally initiate broadcasting of one or more indicators, which may indicate that one or more heatmaps is available for download to a mobile device, such as mobile device 103. By way of example but not limitation, processing unit 460 may include one or more processors, controllers, microprocessors, microcontrollers, application specific integrated circuits, digital signal processors, programmable logic devices, field programmable gate arrays, and the like, or any combination thereof.

Memory 462 of transceiver 410 may be representative of any data storage mechanism. Memory 462 may include, for example, a primary memory 464 or a secondary memory 468. Primary memory 464 may include, for example, a random access memory, read only memory, etc. While illustrated in this example as being separate from processing unit 460, it should be understood that all or part of primary memory 464 may be provided within or otherwise co-located/coupled with processing unit 460 by way of bus 458.

Secondary memory 468 may include, for example, the same or similar type of memory as primary memory or one or more data storage devices or systems, such as, for example, a disk drive, an optical disc drive, a tape drive, a solid state memory drive, etc. In certain implementations, secondary memory 468 may be operatively receptive of, or otherwise configurable to couple to, a computer-readable medium 445. Computer-readable medium 445 may include, for example, any non-transitory medium that can carry or make accessible data, code or instructions for one or more of the devices in system 435. Computer-readable medium 445 may also be referred to as a storage medium.

FIG. 4C is a flowchart showing transceiver operations in mobile device-based transceiver parameter reporting according to an embodiment. The method of FIG. 4C may begin at block 470, which may comprise a transceiver device receiving a probe request message from a first mobile device. A probe message may comprise one or more indicators, which may indicate that the first mobile device is capable of reporting one or more transceiver signal parameter measurements. At block 472, a transceiver device may transmit a probe response message to the first mobile device, which may indicate that the transceiver device is capable of utilizing the one or more reported transceiver signal parameter measurements. Responsive to transmission of a probe response message, the transceiver may, at block 475, receive one or more transceiver signal parameter measurements from a first mobile device. At block 485, the transceiver may process the one or more transceiver signal parameter measurements to construct or update one or more heatmaps.

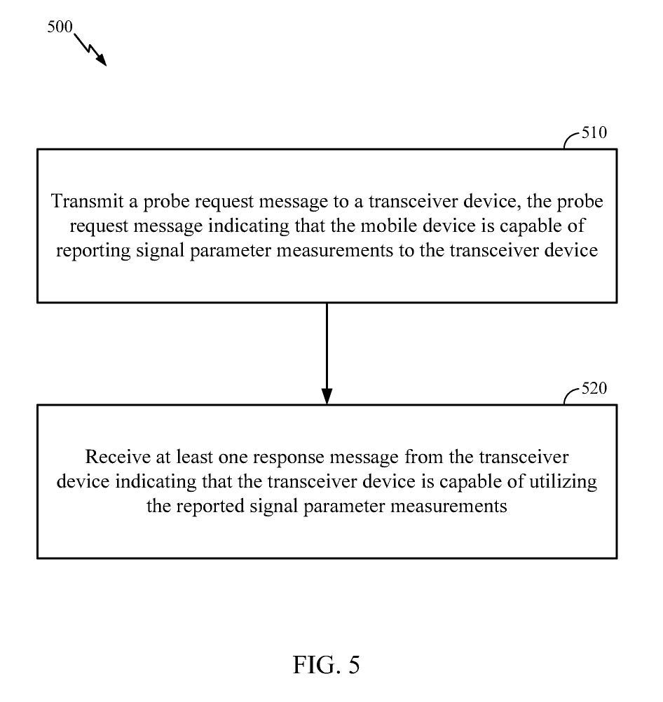

FIG. 5 is a flowchart 500 for a method of mobile device-based transceiver parameter reporting according to an embodiment. The method of FIG. 5 differs from the method of FIG. 4C in that the method of FIG. 5 may be directed more towards the operations and/or functions of a mobile device as opposed to the operations and/or functions of a wireless transceiver. The method of FIG. 5 may begin at block 510, in which a mobile device may transmit a message, such as a probe request message, to the transceiver. A transceiver device may, at least in some embodiments, comprise a wireless access point, for example. A probe request message may indicate that the mobile device is capable of reporting signal parameter measurements and reporting results of such measurements to the transceiver device. The method may continue at block 520, in which a mobile device may receive a response message, such as a probe response message, from a wireless transceiver device. A response message may indicate that the transceiver device is capable of utilizing reported signal parameter measurements. Transceiver signal parameter measurements may be assembled, processed, and used to construct or update, for example, an RSSI heatmap and/or an RTT heatmap for an indoor area.

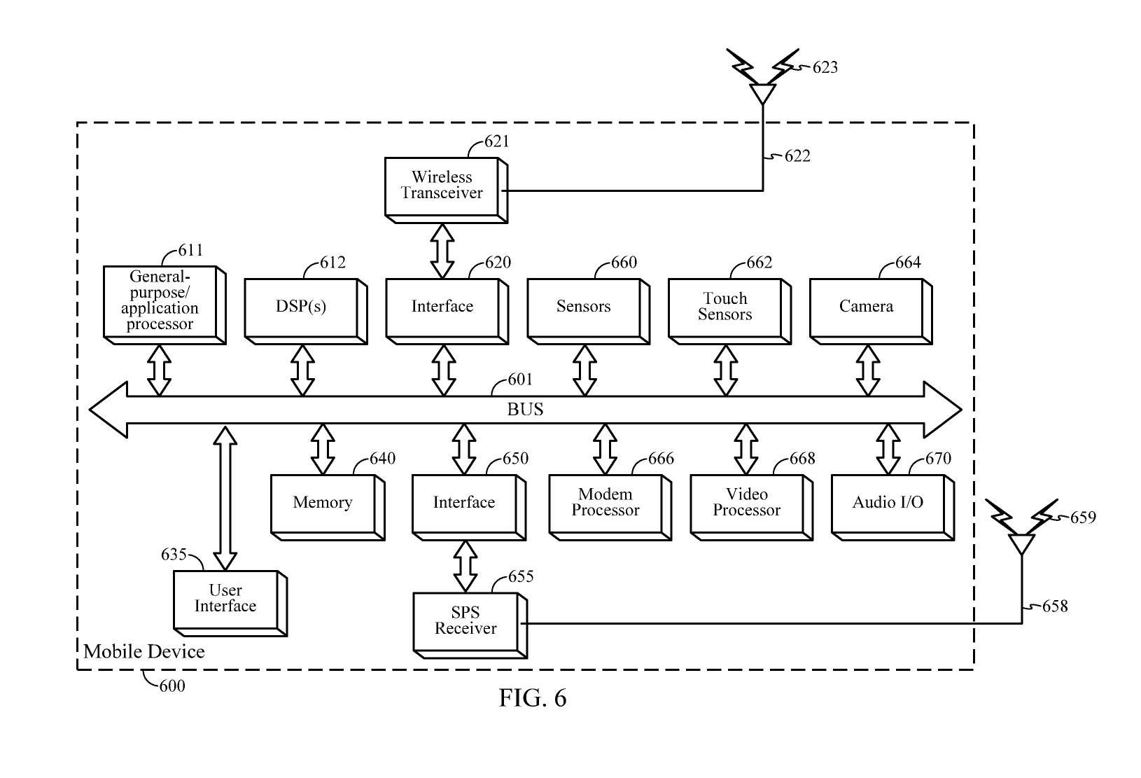

FIG. 6 is a schematic diagram 600 of a mobile device according to an embodiment. Mobile devices of FIGS. 1-6 may comprise one or more features of mobile device 600 shown in FIG. 6. In certain embodiments, mobile device 600 may also comprise wireless transceiver 621, which may be capable of transmitting and receiving wireless signals 623 via antenna 622 over a wireless communication network. Wireless transceiver 621 may be coupled to bus 601 by way of wireless transceiver bus interface 620. Wireless transceiver bus interface 620 may, in some embodiments be at least partially integrated with wireless transceiver 621. Some embodiments may include, for example, multiple wireless transceivers 621 and wireless antennas 622 to enable transmitting and/or receiving signals according to corresponding multiple wireless communication standards for Wide Area Networks (WAN), Wireless Local Area Networks (WLAN), Personal Area Networks (PAN), etc. Such as, for example, versions of IEEE Std. 802.11, CDMA, WCDMA, LTE, UMTS, GSM, AMPS, Zigbee, and Bluetooth, just to name a few examples.

Mobile device 600 may also comprise SPS receiver 655 capable of acquiring and processing SPS signals 659 via SPS antenna 658. SPS receiver 655 may also process, in whole or in part, acquired SPS signals 659 for estimating a location of mobile device 600. In some embodiments, general-purpose processor(s) 611, memory 640, DSP(s) 612 and/or specialized processors (not shown) may also be utilized to process acquired SPS signals, in whole or in part, and/or calculate an estimated location of mobile device 600, in conjunction with SPS receiver 655. Storage of SPS or other signals for use in performing positioning operations may be performed in memory 640 or registers (not shown).

Also shown in FIG. 6, mobile device 600 may comprise digital signal processor(s) (DSP(s)) 612 that may comprise an interface to bus 601. General-purpose processor(s) 611 may comprise an interface to bus 601 and may comprise an interface to memory 640. A bus interface may be integrated with the DSP(s) 612, general-purpose processor(s) 611 and memory 640. In various embodiments, functions may be performed in response to execution of one or more machine-readable instructions stored in memory 640 such as on a computer-readable storage medium, such as RAM, ROM, FLASH, or disc drive, just to name a few example. The one or more instructions may be executable by general-purpose processor(s) 611, specialized processors, or DSP(s) 612. Memory 640 may comprise a non-transitory processor-readable memory and/or a computer-readable memory that stores software code (programming code, instructions, etc.) that are executable by processor(s) 611 and/or DSP(s) 612 to perform functions described herein.

Also shown in FIG. 6, a user interface 635 may comprise any one of several devices such as, for example, a speaker, microphone, display device, vibration device, keyboard, touch screen, just to name a few examples. In a particular implementation, user interface 635 may enable a user to interact with one or more applications hosted on mobile device 600. For example, devices of user interface 635 may store analog or digital signals on memory 640 to be further processed by DSP(s) 612 or general-purpose processor 611 in response to action from a user. Similarly, applications hosted on mobile device 600 may store analog or digital signals on memory 640 to present an output signal to a user. In implementations, a user may interact with user interface 635 to determine an estimated location of the mobile device. The estimated location may be determined by acquiring signals from one or more space vehicles of an SPS, one or more cellular base stations, one or more wireless access points, and so forth. In response to downconversion, demodulation, and signal processing operations, wireless transceiver 621 may transmit one or more RSSI measurements and one or more position estimates to a wireless transceiver. Responsive to detection of predetermined events, wireless transceiver 621 may transmit additional estimated locations and RSSI measurements to a wireless transceiver, such as a wireless access point.

In an implementation, mobile device 600 may include a dedicated audio input/output (I/O) device 670 comprising, for example, a dedicated speaker, microphone, digital to analog circuitry, analog to digital circuitry, amplifiers, and/or gain control. It should be understood, however, that this is merely an example of how an audio I/O may be implemented in a mobile device, and that claimed subject matter is not limited in this respect. In another implementation, mobile device 600 and may comprise touch sensors 662 responsive to touching or pressure on a keyboard or touch screen device.

Mobile device 600 may also comprise a dedicated camera device 664 for capturing still or moving imagery. Camera device 664 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 611 or DSP(s) 612. Alternatively, a dedicated video processor 668 may perform conditioning, encoding, compression, or manipulation of signals representing captured images. Additionally, video processor 668 may decode/decompress stored image data for presentation on a display device (not shown) on mobile device 600.

Mobile device 600 may also comprise sensors 660 coupled to bus 601, which may include, for example, inertial sensors and environment sensors. Inertial sensors of sensors 660 may comprise, for example accelerometers (e.g., collectively responding to acceleration of mobile device 600 in three dimensions), one or more gyroscopes or one or more magnetometers (e.g., to support one or more compass applications). Environment sensors of mobile device 600 may comprise, for example, temperature sensors, RF sensors, barometric pressure sensors, ambient light sensors, camera imagers, microphones, just to name few examples. Sensors 660 may generate analog or digital signals that may be stored in memory 640 and processed by general purpose application processor 611 in support of one or more applications such as, for example, applications directed to positioning or navigation operations.

In a particular implementation, mobile device 600 may comprise a dedicated modem processor 666 capable of performing baseband processing of signals received and downconverted at wireless transceiver 621 or SPS receiver 655. Similarly, modem processor 666 may perform baseband processing of signals to be upconverted for transmission by wireless transceiver 621. In alternative implementations, instead of comprising a dedicated modem processor, baseband processing may be performed by a general-purpose processor or DSP (e.g., general purpose/application processor 611 or DSP(s) 612). It should be understood, however, that these are merely examples of structures that may perform baseband processing, and that claimed subject matter is not limited in this respect.

In a particular implementation, mobile device 600 may be capable of performing one or more of the actions set forth in the process of FIG. 6. For example, general-purpose application processor 611 may perform, or at least initiate, all or a portion of actions 305, 310, 315, 330, 355, 357, 359, and 361 as well as actions at blocks 510 and/or 520.

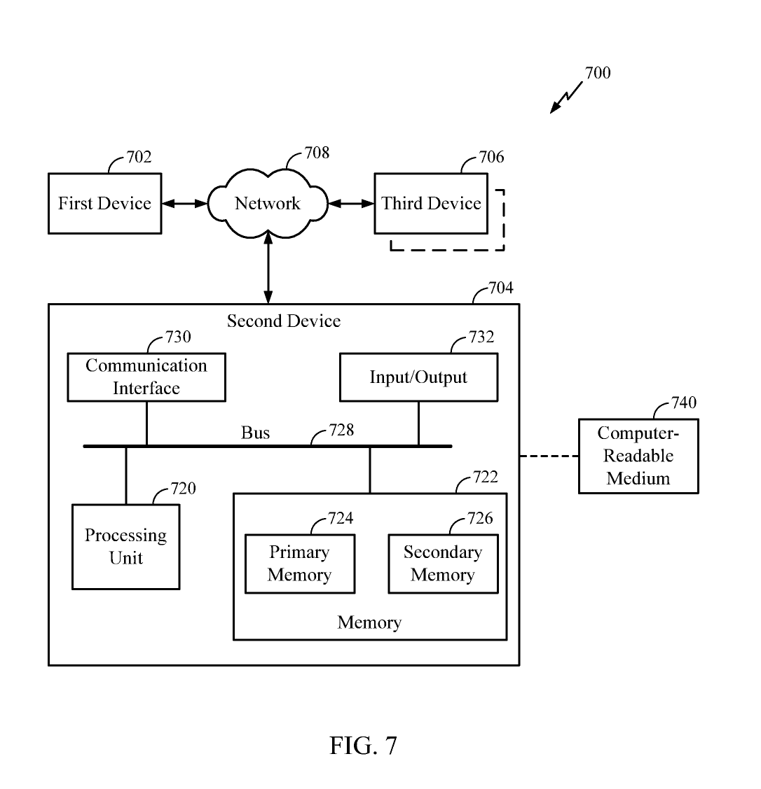

FIG. 7 is a schematic diagram illustrating an example system 700 that may include one or more devices configurable to implement techniques or processes described above, for example, in connection with FIGS. 3A-3D and FIG. 5. System 700 may include, for example, a first device 702, a second device 704, and a third device 706, which may be operatively coupled through a wireless communications network 708. In an aspect, first device 702 may comprise a server capable of providing positioning assistance data such as, for example, an RSSI and/or an RTT heatmap. In another aspect, a mobile device may notify a wireless transceiver that the mobile device is capable of reporting RSSI measurements to the wireless transceiver. Second and third devices 704 and 706 may comprise mobile devices, in an aspect. In addition, in an aspect, wireless communications network 708 may comprise one or more cellular base stations and/or wireless access points, for example. However, claimed subject matter is not limited in scope in these respects.

First device 702, second device 704 and third device 706, as shown in FIG. 7, may be representative of any device, appliance or machine (e.g., such as wireless transceiver 115 or servers 140, 150 or 155 as shown in FIG. 1) that may be configurable to exchange data over wireless communications network 708. By way of example but not limitation, any of first device 702, second device 704, or third device 706 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 702, 704, and 706, respectively, may comprise one or more of a base station almanac server, a base station, or a mobile device in accordance with the examples described herein.

Similarly, communications network 708 (e.g., in a particular of implementation of network 130 shown in FIG. 1), may be representative of one or more communication links, processes, or resources configurable to support the exchange of data between at least two of first device 702, second device 704, and third device 706. By way of example but not limitation, communications network 708 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 706, there may be additional like devices operatively coupled to wireless communications network 708. Thus, by way of example but not limitation, second device 704 may include at least one processing unit 720 that is operatively coupled to a memory 722 through a bus 728. It is recognized that all or part of the various devices and networks shown in system 700, and the processes and methods as further described herein, may be implemented using or otherwise including hardware, firmware, software, or any combination thereof.

Processing unit 720 is representative of one or more circuits configurable to perform at least a portion of a data computing procedure or process. By way of example but not limitation, processing unit 720 may include one or more processors, controllers, microprocessors, microcontrollers, application specific integrated circuits, digital signal processors, programmable logic devices, field programmable gate arrays, and the like, or any combination thereof.

Memory 722 is representative of any data storage mechanism. Memory 722 may include, for example, a primary memory 724 or a secondary memory 726. Primary memory 724 may include, for example, a random access memory, read only memory, etc. While illustrated in this example as being separate from processing unit 720, it should be understood that all or part of primary memory 724 may be provided within or otherwise co-located/coupled with processing unit 720.

In particular implementation, second device 704 may be capable of rendering an estimated location of a mobile device. For example, second device 704 may receive parameters in messages receiving from a client STA, receiving STA and/or sending STA through communication network 708 for use in forming expressions for use in computing an estimated location of the client STA. In certain implementations, a transceiver (not shown) of a second device 704 may transmit an estimated location of second device 704 to first device 702. Responsive to computing an estimated location, in response to determining that second device 704 is capable of providing RSSI measurements to first device 702 may transmit an estimated location of second device 704 paired, associated, or related with an RSSI measurement. Second device 704 may display one or more estimated locations by way of a display device (not shown) coupled to, for example bus 728. Secondary memory 726 may include, for example, the same or similar type of memory as primary memory or one or more data storage devices or systems, such as, for example, a disk drive, an optical disc drive, a tape drive, a solid state memory drive, etc. In certain implementations, secondary memory 726 may be operatively receptive of, or otherwise configurable to couple to, a computer-readable medium 740. Computer-readable medium 740 may include, for example, any non-transitory medium that can carry or make accessible data, code or instructions for one or more of the devices in system 700. Computer-readable medium 740 may also be referred to as a storage medium.

Second device 704 may include, for example, a communication interface 730 that provides for or otherwise supports the operative coupling of second device 704 to at least wireless communications network 708. By way of example but not limitation, communication interface 730 may include a network interface device or card, a modem, a router, a switch, a transceiver, and the like.

Second device 704 may include, for example, an input/output device 732. Input/output device 732 is representative of one or more devices or features that may be configurable to accept or otherwise introduce human or machine inputs, or one or more devices or features that may be configurable to deliver or otherwise provide for human or machine outputs. By way of example but not limitation, input/output device 732 may include an operatively configured display, speaker, keyboard, mouse, trackball, touch screen, data port, etc.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Memory 722 may represent any suitable or desired information storage medium. For example, memory 722 may include a primary memory 724 and a secondary memory 726. Primary memory 724 may include, for example, a random access memory, read only memory, etc. While illustrated in this example as being separate from a processing unit, it should be appreciated that all or part of primary memory 724 may be provided within or otherwise co-located/coupled with processing unit 720. Secondary memory 726 may include, for example, the same or similar type of memory as primary memory or one or more information storage devices or systems, such as, for example, a disk drive, an optical disc drive, a tape drive, a solid state memory drive, etc. In certain implementations, secondary memory 726 may be operatively receptive of, or otherwise enabled to be coupled to, a non-transitory computer-readable medium 740.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered a self-consistent sequence of operations or similar signal processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method comprising, at a mobile device:
transmitting a probe request message to a transceiver device, said probe request message indicating that said mobile device is capable of reporting signal parameter measurements to said transceiver device; and
receiving at least one response message from said transceiver device indicating that said transceiver device is capable of utilizing said reported signal parameter measurements.

2. The method of claim 1, and further comprising:
transmitting one or more signal parameter measurements from said mobile device and one or more estimated locations of said mobile device to said transceiver device for use in generating positioning assistance data, said one or more signal parameter measurements comprising received signal strength (RSSI) measurements, round trip time (RTT) measurements, or combinations thereof.

3. The method of claim 2, and further comprising:
said mobile device computing said one or more estimated locations based, at least in part, on one or more measurements obtained from one or more sensors of said mobile device.

4. The method of claim 2, wherein transmitting said one or more signal parameter measurements comprises transmitting said one or more signal parameter measurements in response to at least one predetermined event.

5. The method of claim 4, wherein said at least one predetermined event comprises detection of a movement of said mobile device.

6. The method of claim 4, wherein said at least one predetermined event comprises detection of a user input to said mobile device.

7. The method of claim 4, wherein said at least one predetermined event comprises detection of a time of day.

8. The method of claim 4, wherein said at least one predetermined event comprises detecting expiration of a timer that initiates transmitting said signal parameter measurements at scheduled intervals.

9. The method of claim 4, wherein said at least one predetermined event comprises detection of one or more requests for said mobile device to report said signal parameter measurements.

10. The method of claim 2, wherein said one or more signal parameter measurements transmitted from said mobile device comprises one or more qualifiers to indicate reliability of said one or more signal parameter measurements or to indicate reliability of said one or more estimated locations of said mobile device.

11. A mobile device, comprising:
a transceiver; and
one or more processors coupled to said transceiver to:
initiate transmission of one or more probe request messages indicating that said mobile device is capable of reporting parameter measurements of received wireless signals; and
obtain one or more response messages received at said transceiver indicating that a wireless access point is capable of utilizing said reported parameter measurements of said received wireless signals.

12. The mobile device of claim 11, wherein said one or more processors are additionally to:
initiate transmission of messages, through said transceiver, comprising said parameter measurements of said received wireless signals and one or more estimated locations of said mobile device to said wireless access point.

13. The mobile device of claim 12, wherein said initiation of said transmission of said messages is performed in response to detection of at least one predetermined event.

14. The mobile device of claim 13, wherein said at least one predetermined event comprises expiration of a timer that initiates said transmission of said parameter measurements of said received wireless signals at scheduled intervals.

15. The mobile device of claim 13, wherein said at least one predetermined event comprises detection of one or more movements of said mobile device.

16. The mobile device of claim 13, wherein said at least one predetermined event comprises detection of one or more user inputs to said mobile device.

17. The mobile device of claim 13, wherein said at least one predetermined event comprises detection of one or more requests from said wireless access point for said mobile device to report one or more parameter measurements of said received wireless signals.

18. The mobile device of claim 11, wherein said one or more probe request messages comprises one or more of a vendor-specific identifier and a vendor-specific information element transmitted by said wireless access point.

19. A method comprising, at a transceiver device:
receiving a probe request message from a first mobile device, said probe request message indicating that said first mobile device is capable of reporting one or more signal parameter measurements;
transmitting a probe response message to said first mobile device indicating that said transceiver device is capable of utilizing said one or more reported signal parameter measurements;
receiving said one or more reported signal parameter measurements from said first mobile device; and
processing said one or more reported signal parameter measurements to construct or update one or more heatmaps.

20. The method of claim 19, wherein at least one of said one or more heatmaps corresponds to a localized heatmap for said transceiver device.

21. The method of claim 19, further comprising:
transmitting said one or more reported signal parameter measurements, one or more heatmaps, or a combination thereof, to a location server.

22. The method of claim 19, further comprising:
broadcasting one or more messages indicating that said one or more heatmaps is available for downloading.

23. The method of claim 19, wherein said processing said one or more reported signal parameter measurements comprises updating one or more heatmaps based, at least in part, on said one or more reported signal parameter measurements.

24. The method of claim 19, wherein said processing said one or more reported signal parameter measurements comprises:
assigning a greater weight to one or more relatively high reliability reported signal parameter measurements; and
assigning a lesser weight to one or more relatively low reliability reported signal parameter measurements.

25. The method of claim 19, further comprising:
receiving an estimated location from said first mobile device; and
relating said estimated location with said one or more reported signal parameter measurements.

26. A transceiver device, comprising:
a communication interface;
one or more processors, coupled to said communication interface, configured to:
obtain one or more messages from a mobile device indicating that said mobile device is capable of reporting one or more signal parameter measurements; and
initiate transmission of one or more indications, through said communication interface, that said transceiver device is capable of utilizing said one or more reported signal parameter measurements from said mobile device to construct or update one or more heatmaps.

27. The transceiver device of claim 26, wherein said one or more processors are additionally configured to:
initiate transmission of said one or more reported signal parameter measurements, said one or more heatmaps, or a combination thereof, to a location server.

28. The transceiver device of claim 26, wherein said one or more processors are additionally configured to:
initiate broadcast of one or more messages indicating that said one or more heatmaps is available for download.

29. The transceiver device of claim 26, wherein said one or more processors are additionally configured to:
assign a greater weight to one or more relatively high reliability reported signal parameter measurements; and
assign a lesser weight to one or more relatively low reliability reported signal parameter measurements.

30. The transceiver device of claim 26, wherein said one or more processors are additionally to:
relate an estimated location received from said mobile device with said one or more reported signal parameter measurements.
